(19) United States
(12) Patent Application Publication
(10) Pub. No.: US 2022/0049155 A1
(43) Pub. Date: Feb. 17, 2022

(54) Nanoclay Assisted High Temperature Crosslinked Fracturing Fluids

(71) Applicant: Saudi Arabian Oil Company, Dhahran (SA)

(72) Inventor: Feng Liang, Cypress, TX (US)

(21) Appl. No.: 17/403,123

(22) Filed: Aug. 16, 2021

Related U.S. Application Data
(60) Provisional application No. 63/066,600, filed on Aug. 17, 2020.

(51) Int. Cl. C09K 8/68; C09K 8/88

(52) U.S. Cl. CPC C09K 8/685; C09K 2208/10; C09K 2208/28; C09K 8/887

(57) ABSTRACT

A fracturing fluid is provided including a mixture of an aqueous copolymer composition including a copolymer, the copolymer having acrylamide monomer units, or acrylic acid monomer units, or both, or salts thereof. The molar includes a crosslinker and a nanoclay.

### CLAIM OF PRIORITY

This application claims priority to U.S. Provisional Application Ser. No. 63/066,600, filed on Aug. 17, 2020, the entire contents of which is hereby incorporated by reference.

### TECHNICAL FIELD

This document relates to methods and compositions used in hydraulic fracturing operations, particularly those with reduced friction for crosslinked fracturing fluid systems applicable for temperatures of up to 450° F. and higher.

### BACKGROUND

The reduction of friction during fracturing treatment in the oilfield is an ongoing challenge. In unconventional fields, slickwater is the main fracturing fluid type used in the hydraulic fracturing treatment. Since water is a Newtonian fluid, it generates high treatment pressures due to friction pressure loss at high pumping rate. To reduce the friction pressure, very low concentration of high molecular weight of acrylamide-based polymers are added to the fluid, which is called slickwater treatment. However due to its relative low viscosity, the slickwater treatment only can carry 0.2-2 pound per gallon (ppg) (0.024-0.24 kilogram/liter) of proppants and is also typically pumped at higher pumping rate, for example, 60-110 barrels per minutes (bpm).

Crosslinked fracturing fluids such as polysaccharide-based fluids are designed to transport higher proppant concentrations and reduce leakoff. Guar-based fracturing fluids are commonly used primarily because of their abundance, relative low cost, and capability to work at up to 350° F. (177° C.) when formulated at high pH (for example, greater than 9.5). One notable disadvantage, however, for most guar-based fracturing fluids is the insoluble residue in guar which tends to cause permeability reduction. Another disadvantage for using guar-based fluids at high pH is the tendency for forming divalent ion scales at high pH. In general, thermally stable synthetic polymers, such as acrylamide-based polymers are considered to be residue-free. These polymers can be used for preparing fracturing fluids around 300-450° F. (149-232° C.) or more. However, a high dosage of acrylamide-based polymers may still cause formation damage due to factors such as incomplete degradation.

### SUMMARY

An embodiment described herein provides a fracturing fluid. The fracturing fluid includes a mixture of an aqueous copolymer composition including a copolymer, the copolymer including acrylamide monomer units, or acrylic acid monomer units, or both, or salts thereof. The mixture also includes a crosslinker including a metal and a nanoclay.

Another embodiment described herein provides a method of treating a subterranean formation. The method includes introducing a fracturing fluid into the subterranean formation, wherein the fracturing fluid includes an aqueous copolymer composition including a copolymer, the copolymer including acrylamide monomer units, or acrylic acid monomer units, or both, or salts thereof. The fracturing fluid includes a crosslinker including a metal and a nanoclay, wherein the fracturing fluid includes greater than 1 pounds per thousand gallons (pptg) of the nanoclay. The method includes crosslinking the fracturing fluid in the subterranean formation to yield a crosslinked fracturing fluid.

Another embodiment described herein includes a fracturing fluid. The fracturing fluid includes a mixture of an aqueous copolymer composition including a copolymer, the copolymer including 2-acrylamido-2-methylpropanesulfonic acid, acrylamide, and acrylic acid monomer units, or a salt thereof, and wherein the copolymer includes 1 mol % to 55 mol % of the 2-acrylamido-2-methylpropanesulfonic acid monomer units. The mixture includes a crosslinker including a metal and a nanoclay, wherein the nanoclay includes particles less than about 25 micrometers in size.

### DESCRIPTION OF DRAWINGS

FIG. 1 is a plot of the viscosity and temperature versus time for Example 1.

FIG. 2 is a plot of the viscosity of hybrid fluids with addition of hydrophilic bentonite nanoclay at different concentrations.

FIG. 3 is a plot that shows the viscosity of the nanoclay assisted fluid in Example 2 with the addition of a viscosity breaker.

FIG. 4 is a process flow diagram of a method for treating a formation with a fracturing fluid comprising the mixtures described herein

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Crosslinked Fracturing Fluid Systems & Compositions

Provided in examples herein are fracturing fluids and crosslinked fracturing fluids. The fracturing fluids include an aqueous composition including a copolymer and a crosslinking solution including a crosslinker. The crosslinked fracturing fluids include a crosslinked product of the copolymer and the crosslinker.

In some embodiments, the copolymer includes at least three monomer units: 2-acrylamido-2-methylpropanesulfonic acid (AMPSA), acrylamide, and acrylic acid or a related salt thereof. The copolymer typically has less than 55 mol % of AMPSA. In some embodiments, the copolymer has less than 20 mol % AMPSA. In some embodiments, the copolymer has between 1 mol % and 55 mol %, between 1 mol % and 40 mol %, between 1 mol % and 25 mol %, between 10 mol % and 30 mol %, between 12 mol % and 20 mol %, or between 13 mol % and 17 mol % AMPSA. In some embodiments, the copolymer has about 1 mol %, 5 mol %, 10 mol %, 20%, 25 mol %, 30 mol %, 35 mol %, 40 mol %, 45 mol %, 50 mol %, or 55 mol % AMPSA. The copolymer can also have about 15 mol % of the AMPSA. The copolymer can have about 0.1 mol % to about 30 mol % of acrylic acid. In some embodiments, the copolymer is a terpolymer including AMPSA, acrylamide, and acrylic acid or a related salt thereof. The terpolymer has less than 55 mol % AMPSA. In some embodiments, the terpolymer has less than 20 mol % AMPSA. In some embodiments, the terpolymer has between 5 mol % and 40 mol %, between 10 mol % and 30 mol %, between 12 mol % and 20 mol %, or between 13 mol % and 17 mol % AMPSA. In some embodiments, the terpolymer has about 5 mol %, 10 mol %, 20%, 25 mol %, 30 mol %, 35 mol %, 40 mol %, 45 mol %, 50 mol %, or 55 mol % AMPSA. The terpolymer can also have about 15 mol % AMPSA. The terpolymer can have about 0.1 mol % to about 30 mol % of acrylic acid. In an embodiment, the amount of acrylic acid is greater than 0 mol %.

The copolymers provided herein can be combined with crosslinkers to produce crosslinked fluids that function as efficient proppant transportation fluids at low polymer loadings. For example, it has been discovered that a fracturing fluid having a copolymer concentration of less than 30 pounds per thousand gallons (pptg) can produce crosslinked fluids when combined with a crosslinker, even at a low crosslinker/copolymer ratio for use at 450° F. or higher. In some embodiments, a fracturing fluid has a copolymer in a concentration of less than 50 pptg (6.0 kg/kL), less than 35 pptg (4.2 kg/kL), less than 30 pptg (3.6 kg/kL), less than 25 pptg (3.0 kg/kL), or less than 20 pptg (2.4 kg/kL). In some embodiments, a fracturing fluid includes a copolymer in a concentration between 10 (1.2 kg/kL) and 40 pptg (4.8 kg/kL), between 15 (1.8 kg/kL) and 35 pptg (4.2 kg/kL), or between 20 (2.4 kg/kL) and 30 pptg (3.6 kg/kL). In some embodiments, a fracturing fluid includes a copolymer in a concentration of about 10 pptg (1.2 kg/kL), 15 pptg (1.8 kg/kL), 20 pptg (2.4 kg/kL), 25 pptg (3.0 kg/kL), 30 pptg (3.6 kg/kL), 35 pptg (4.2 kg/kL), 40 pptg (4.8 kg/kL), 45 pptg (5.4 kg/kL), or 50 pptg (6.0 kg/kL). For example, for a 400° F. (204° C.) application, a fracturing fluid including a copolymer at a concentration of about 30 pptg (3.6 kg/kL) can be used. For example, for a 300° F. (149° C.) application, a fracturing fluid including a copolymer at a concentration of about 20 pptg (2.4 kg/kL) can be used.

However, in general, higher fraction loss is seen for crosslinked fracturing fluids with higher viscosities. In this situation, higher horsepower for fracturing will be needed in order to maintain the same pumping rate for crosslinked fluid with higher viscosities. Accordingly, a fluid system with controllable friction for crosslinked fracturing fluids during pumping is needed.

Accordingly, in examples described herein, water dispersible nanoclay is added to the fracturing fluid to function as a lubricating agent, or friction reducing additive. The water dispersible nanoclay will serve as a lubricant in the crosslinked polymeric network to reduce the friction during pumping. In various embodiments, the nanoclay has a phyllosilicate or sheet structure with a thickness of about 1 nanometer (nm) and surfaces between about 50-150 nm in one dimension and less than 25 microns in other dimensions. An example of a water dispersible nanoclay additive that is used to reduce the fluid friction in some embodiments of the fracturing fluid system is hydrophilic bentonite nanoclay, for example, available from Nanocor Corporation. The particle size of this nanoclay is less than 25 microns. In various embodiments, a fracturing fluid includes nanoclay at a concentration of about 1 pptg (0.12 kg/kL), 2 pptg (0.24 kg/kL), 5 pptg (0.60 kg/kL), 10 pptg (1.2 kg/kL), or 20 pptg (2.4 kg/kL). In some embodiments, about 2 pptg (0.24 kg/kL) of nanoclay is used. In some embodiments, the nanoclay is added to the fracturing fluid as a dry powder after rehydrating the terpolymer.

A terpolymer of AMPSA, acrylamide, and acrylic acid or a related salt thereof may be obtained by copolymerizing AMPSA, acrylic acid and acrylamide in specified amounts. The terpolymer can also be produced by initially polymerizing AMPSA and acrylamide, and hydrolyzing the acrylamide to generate desired amounts of acrylic acid, such that the number of moles of acrylamide and acrylic acid monomer units is equal to total number of moles of acrylamide initially employed. The copolymer can be employed as water-in-oil emulsion or suspension concentrate, or as a solid dissolved in an aqueous fluid.

Fracturing fluids provided herein can include low ratios of crosslinker to copolymer. Suitable crosslinkers typically include a metal, metal oxide, or both. In some embodiments, the crosslinker includes zirconium. Suitable zirconium crosslinkers include, for example, zirconium complexes in which zirconium is complexed with ligands such as lactate salts (for example, sodium zirconium lactate), triethanolamines, alkoxides (for example, isopropoxide and propoxide), 2,2′-iminodiethanol, and mixtures of these ligands. The crosslinker may be suitably dissolved in aqueous fluids, non-aqueous fluids or liquids (for example, alcohol such as n-propanol), and the combination of aqueous, water-miscible non-aqueous solvents (for example, alcohols and aminoalcohols). TYZOR 212, available from Dorf Ketal as a solution in n-propanol, is one example of a Zr crosslinker. When 20 pptg (2.4 kg/kL) to 30 pptg (3.6 kg/kL) of the copolymer is present in the fracturing fluid and the crosslinking solution is TYZOR 212, a weight ratio of Zr to copolymer or terpolymer may be in a range of about 0.01 to about 0.1 (such as about 0.02 to about 0.08 or about 0.02 to about 0.04), and a weight percentage of Zr in the fracturing fluid may be in a range of about 0.001 wt % to about 0.24 wt %.

Crosslinkers suitable for fracturing fluid may also include titanium (Ti) crosslinkers. Suitable titanate crosslinkers include, for example, titanate crosslinkers with ligands such as lactates and triethanolamines, and mixtures thereof, optionally delayed with hydroxyacetic acid. Crosslinkers suitable for fracturing fluid may also include aluminum (Al) crosslinkers, chromium (Cr) crosslinkers, iron (Fe) crosslinkers, hafnium (Hf) crosslinkers, and combinations thereof. In some embodiments, a crosslinking solution including about 7 wt % to about 20 wt % of a metal crosslinker can be present at a concentration of about 0.1 gpt (liter/kiloliter or L/kL) to about 5.0 gpt (L/kL), about 0.5 gpt (L/kL) to about 1.5 gpt (L/kL), or about 0.9 to about 1.1 gpt (L/kL) of the fracturing fluid.

Fracturing fluids provided herein have a similar or better gel thermal stability as compared to other fracturing fluids including copolymers having a higher mol % of AMPSA and/or having higher copolymer loadings. In some embodiments, fracturing fluids described herein with a 25 pptg (3.0 kg/kL) copolymer loading maintain a viscosity of at least 300 cP for 20 to 150 minutes when subjected to a 100 s⁻¹ shear rate at a temperature of 300° F. (149° C.). Fracturing fluids provided herein can be used at temperatures between 300° F. (149° C.) and 450° F. (232° C.) or higher, and typically have a pH in a range of 5 to 7 or 5.5 to 6.5. Additionally, a high crosslinker concentration is not required, thereby further reducing the costs associated with the fracturing fluid.

In some embodiments, fracturing fluids provided herein are formed by mixing a copolymer provided herein with an aqueous carrier, such as water. The aqueous carrier can include water, fresh water, brine, produced water, flowback water, brackish water, Arab-D-brine, sea water, or combinations thereof. In some embodiments, the water is field water. In some embodiments, the field water has less than 50,000 mg/L of total dissolved solids (TDS). In some embodiments, the field water has between 500 and 20,000 mg/L TDS, between 700 and 10,000 mg/L TDS, between 800 and 2000 mg/L TDS, or between 1,000 and 1,500 mg/L TDS. In some embodiments, the field water has about 500 mg/L TDS, 600 mg/L TDS, 700 mg/L TDS, 800 mg/L TDS, 900 mg/L TDS, 1,000 mg/L TDS, 1,200 mg/L TDS, 1,400 mg/L TDS, 2,000 mg/L TDS, 5,000 mg/L TDS, 10,000 mg/L TDS, 20,000 mg/L TDS, or about 50,000 mg/L TDS.

In some embodiments, the fracturing fluid includes at least one of a gel stabilizer, clay stabilizer, or other suitable additive. In some embodiments, the gel stabilizer includes an antioxidant. In some embodiments, the gel stabilizer includes phenols, polyphenols, di-tertbutyl alkyl phenols, hydroquinone, apigenin, resveratrol, ascorbic acid, tocopherol, sodium bisulfite, sodium hydrogen sulfite, sodium thiosulfate, ammonium thiosulfate, thiourea, or a combination thereof. In some embodiments, the clay stabilizer includes sodium chloride, potassium chloride, ammonia chloride, tetramethylammonium chloride (TMAC), other quaternary molecules, or a combination thereof. In some embodiments, bromides, such as sodium bromide or potassium bromide, is included.

In some embodiments, the fracturing fluid includes a pH adjusting agent. For example, the fracturing fluid can include an acetic acid solution, an acetic acid/acetate buffer solution, or hydrochloric acid. In some embodiments, an acid is added to a fracturing fluid to achieve a pH between about 2 and 7, 3 and 6.5, and 5 and 5.5, or between about 5 and 7 or 5.5 and 6.5.

In some embodiments, a fracturing fluid includes a copolymer, a crosslinker, a gel stabilizer, a clay stabilizer, and a water soluble nanoclay. The copolymer includes acrylamide, acrylic acid, and about 15 mol % AMPSA. The crosslinker is in the form of a crosslinking solution including about 12.4 wt % Zr. In some embodiments, the copolymer is present at a concentration of about 30 pptg (3.6 kg/kL), the crosslinking solution is present at a concentration of about 0.9 gpt (L/kL), the gel stabilizer is present as a gel stabilizer solution at a concentration of about 3.0 gpt (L/kL), and the clay stabilizer is present as a clay stabilizer solution at a concentration of about 2 gpt (L/kL). In some embodiments, the copolymer is present at a concentration of about 25 pptg (3.0 kg/kL), the crosslinking solution is present at a concentration of about 0.9 gpt (L/kL), the gel stabilizer is present at a concentration of about 0.5 gpt (L/kL), and the clay stabilizer is present at a concentration of about 2 gpt (L/kL). In some embodiments, the copolymer is present at a concentration of about 20 pptg (2.4 kg/kL), the crosslinking solution is present at a concentration of about 1.1 gpt (L/kL), the gel stabilizer is present at a concentration of about 0.4 gpt (L/kL), and the clay stabilizer is present at a concentration of about 2 gpt (L/kL). In some embodiments, the nanoclay is present at a concentration of about 5 pptg (0.6 kg/kL)).

In some embodiments, a fracturing fluid includes a terpolymer, a crosslinker, a gel stabilizer, a clay stabilizer, and a water dispersible nanoclay. The terpolymer includes acrylamide, acrylic acid, and about 15 mol % of AMPSA. The crosslinker is in the form of a crosslinking solution including about 12.4 wt % Zr. In some embodiments, the terpolymer is present at a concentration of about 30 pptg, the crosslinker is present at a concentration of about 0.9 gpt (L/kL), the gel stabilizer is present at a concentration of about 3.0 gpt (L/kL), and the clay stabilizer is present at a concentration of about 2 gpt (L/kL). In some embodiments, the terpolymer is present at a concentration of about 25 pptg (3.0 kg/kL), the crosslinking solution is present at a concentration of about 0.9 gpt (L/kL), the gel stabilizer is present at a concentration of about 0.5 gpt (L/kL), and the clay stabilizer is present at a concentration of about 2 gpt (L/kL). In some embodiments, the terpolymer is present at a concentration of about 20 pptg (2.4 kg/kL), the crosslinker is present at a concentration of about 1.1 gpt (L/kL), the gel stabilizer is present at a concentration of about 0.4 gpt (L/kL), and the clay stabilizer is present at a concentration of about 2 gpt (L/kL). In some embodiments, the nanoclay is present at a concentration of about 5 pptg (0.6 kg/kL).

In one embodiment, a fracturing fluid includes a crosslinker including a metal and an aqueous copolymer composition including a copolymer, the copolymer comprising 2-acryl-amido-2-methylpropanesulfonic acid, acrylamide, and acrylic acid monomer units, or a salt thereof. The copolymer may include 1 mol % to 55 mol % of the 2-acrylamido-2-methylpropane-sulfonic acid monomer units. The weight ratio of the metal to the copolymer is in a range of 0.01 to 0.8. The pH of the fracturing fluid may be in a range of about 5 to about 7, or about 5.5 to about 6.5. In one embodiment, the crosslinker is present in an amount sufficient to yield a crosslinked fluid having a viscosity of at least 400 cP at a temperature of 300° F. (149° C.) and a pH of 6.5, measured at 100 s⁻¹ angular velocity.

In some embodiments, a fracturing fluid includes a proppant. Examples of proppants include sand, gravel, glass beads, polymer beads, ground products from shells and seeds (such as walnut hulls), and manmade materials (such as ceramic proppant, bauxite, tetrafluoroethylene materials), fruit pit materials, processed wood, composite particulates prepared from a binder, and fine grade particulates such as silica, alumina, fumed silica, carbon black, graphite, mica, titanium dioxide, meta-silicate, calcium silicate, kaolin, talc, zirconia, boron, fly ash, hollow glass microspheres, solid glass, or a combination thereof.

### Experimental

Chemicals:

M1—The terpolymer used in the below examples is in a water-in-oil emulsion form (30% active) containing 15 mol % of 2-acrylamido-2-methylpropanesulfonic acid (AMPSA), 5 mol % of acrylic acid (AA), and 80 mol % acrylamide (AM).

M2—acetic acid/acetate buffer solution, (PABA-152L from Precision Additives).

M3—Zr crosslinker (TYZOR© 212, with 16.75 wt % ZrO₂ and 12.4 wt % Zr).

M4—gel stabilizer (CELB 225-10-2, available from ChemEOR).

M5—clay stabilizer, (Cla-Web™ from Halliburton).

Procedures:

Proxy Measurement for Friction Measurements

No current laboratory friction loop design can be used to measure the friction for crosslinked fluids due to their relatively high viscosity range in comparison to the linear fluids which are commonly used in the slickwater treatment. Accordingly, viscosity measurements were used as a proxy to indirectly indicate the friction change with addition of the proposed hydrophilic bentonite nanoclay as the friction reducing additive.

“Cup and bob” is a type of rotational rheometer (viscometer) that is based on measuring the torque required to turn an object in a fluid. The torque is a function of the viscosity of the fluid, and is measured at a constant angular velocity. Since viscosity is normally considered in terms of shear stress and shear rates (Eqn. 1), a method is needed to convert from instrument numbers to rheology numbers. Each measuring system used in an instrument has its associated form factors to convert torque to shear stress and to convert angular velocity to shear rate. In Eq. 2 and Eq. 3, C₁ is used as the shear stress form factor and C₂ is used as the shear rate factor.

Viscosity=shear stress/shear rate, (Eq. 1)

wherein:

Shear stress=torque÷C₁; and (Eq. 2)

Shear rate=C₂×angular velocity. (Eq. 3)

In a coaxial cylinder design of viscometer, such as the cup and bob, C₁ and C₂ are calculated using Eqns. 4 and 5:

$$\begin{matrix}{C}_{1} = \frac{1}{3} {r}_{a}^{2} H ; and & ( Eq . 4 ) \\ {C}_{2} = \frac{2 {r}_{i}^{2} {r}_{o}^{2}}{{r}_{a}^{2} ( {r}_{o}^{2} - {r}_{i}^{2} )} . & ( Eq . 5 )\end{matrix}$$

### In Eqns. 4 and 5:

rₐ=(rᵢ+rₒ)/2 is the average radius;
rᵢ is the inner radius;
rₒ is the outer radius; and
H is the height of cylinder.

Thus, viscosity is proportional to the torque. Under the same shear rate, a higher viscosity measurement indicates higher torque, which indicates higher friction during shear. Since the viscosity measurement from the rotational rheometer is related to the torque (moment, M) reading, the viscosity change among different fluid system is expected to reflect the torque changes. As described below, the fluid viscosity is measured under high temperature and high pressure conditions for the desired fluid systems.

Viscosity Measurement under High Temperature and High Pressure.

To measure the viscosity of fracturing fluid systems under high temperature and high pressure subterranean reservoir formation, sample volumes of about 100 mL were prepared for each test and 50 mL aliquots of each fracturing fluid system were injected into a Grace M5600 HPHT rheometer equipped with a B5 bob configuration. Tests were performed using a heating profile and a shear rate of 100 s⁻¹ with desired shear ramps of 100 s⁻¹, 75 s⁻¹, 50 s⁻¹, 25 s⁻¹, 50 s⁻¹, 75 s⁻¹1, and back to 100 s⁻¹1.

### Example 1

In the first example, a fracturing fluid including a synthetic field water (with the composition shown in Table 1), 25 pptg terpolymer (M1), 4.5 pptg buffer solution (M2), 2 gpt gel stabilizer (M4), 2 gpt clay stabilizer (M5), and 0.6 gpt of Zr crosslinker (M3) was prepared. The pH of the mixed fluid was 5.38. The weight ratio of Zr to terpolymer M1 was about 0.0263. The viscosity of the resulting crosslinked fracturing fluid at shear rate of 100 s⁻¹ was measured at 300° F.

TABLE 1
Water Analysis of the formation water.

| Component | Concentration (mg/L) |
|---|---|
| Calcium | 0.27 |
| Magnesium | 1.56 |
| Chloride | 266 |
| Sulfate | 201 |
| Bicarbonate | 198 |

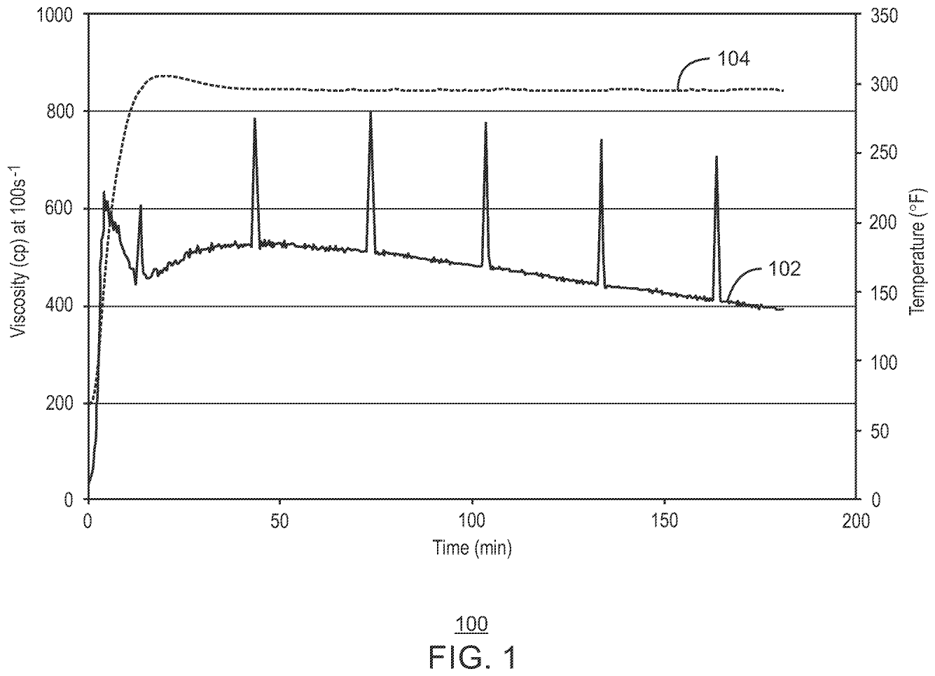

FIG. 1 is a plot 100 of the viscosity 102 and temperature 104 versus time for Example 1. The fracturing fluid maintained a viscosity of greater than 300 cP at a shear rate of 100 s−1 for more than 3 hours.

Example 1 was used as a control for comparison with fluids including the water soluble nanoclay. The hydrophilic bentonite nanoclay from Nanocor Corporation (also supplied from Sigma-Aldrich; CAS number: 1302-78-9), with a size less than 25 microns, was used as the friction reducing additive for reducing the friction of the crosslinked fracturing fluid. It can be noted that the nanoclay does not have the functionality to crosslink with the terpolymer (M1).

In Examples 2-5, the fracturing fluids were prepared with synthetic field water (in Table 1), 25 pound per one thousand gallon (pptg) M1 terpolymer, 4.5 gallon per one thousand gallon buffer solution M2, 2 gpt gel stabilizer M4, 2 gpt clay stabilizer M5, an 0.6 gpt Zr crosslinker (M3) and different concentrations of hydrophilic bentonite nanoclay, as shown in Table 2. As for Example 1, the viscosities of the resulting crosslinked fracturing fluids were measured at a shear rate of 100 s⁻¹ and a temperature of 300° F.

TABLE 2
Amount of nanoclay used in Examples 2-5

| | Amount of | pH of |
|---|---|---|
| Example | nanoclay (pptg) | mixed fluid |
| 2 | 1 | 5.36 |
| 3 | 2 | 5.35 |
| 4 | 5 | 5.39 |
| 5 | 10 | 5.38 |

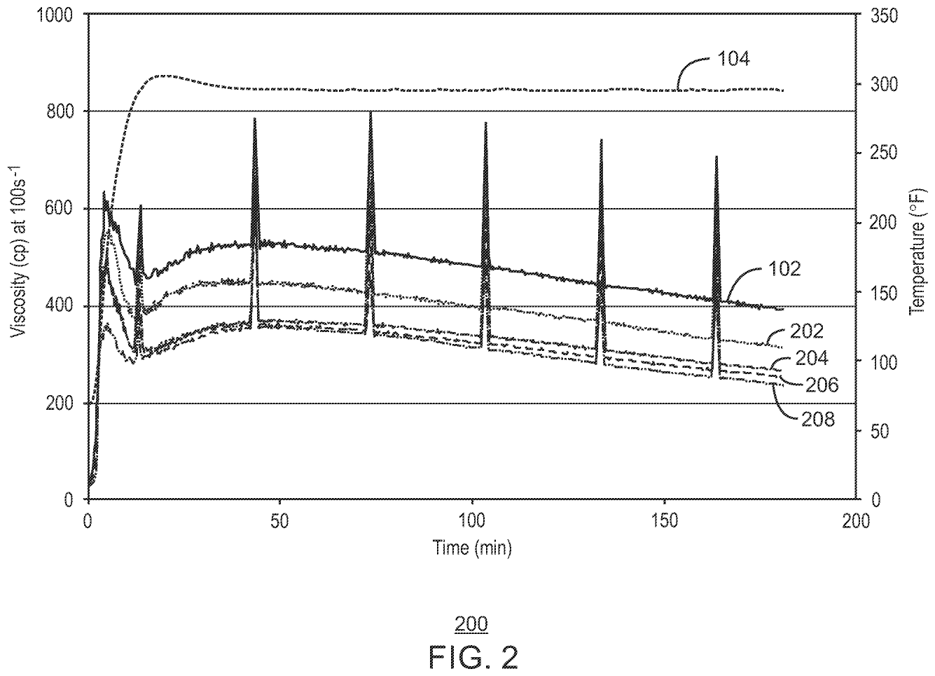

FIG. 2 is a plot 200 of the viscosity of hybrid fluids with addition of hydrophilic bentonite nanoclay at different concentrations. Like numbered items are as described with respect to FIG. 1. The plot 200 shows viscosity 202 versus time for Example 2 (with addition of 1.0 pptg hydrophilic bentonite nanoclay). The plot also shows viscosity 204 versus time for Example 3 (with addition of 2.0 pptg hydrophilic bentonite nanoclay), viscosity 206 versus time for Example 4 (with addition of 5.0 pptg hydrophilic bentonite nanoclay), and viscosity 208 versus time for Example 5 (with addition of 10.0 pptg hydrophilic bentonite nanoclay). It can be seen that with addition of 1.0 pptg of the nanoclay additive, the viscosity 202 is lower than the viscosity 102 of Example 1, which is opposite to what would be expected for a typical synergistic fluid systems, in which the viscosity increases with addition of nanoparticles. With addition of 2.0 pptg of the hydrophilic bentonite nanoclay, the viscosity 204 is further reduced than viscosity 202. However, the viscosity trend seems to plateau with increasing amounts of nanoclay. When the hydrophilic bentonite nanoclay concentration is increased to 5.0 pptg and 10.0 pptg (plot 205), viscosities 206 and 208 are similar to viscosity 204. This indicates that very small dosage of the hydrophilic bentonite nanoclay can achieve the desired results.

Table 3 shows the viscosity of Example 1-5 at 100 s⁻¹ at testing time of 25 min. Percentage of viscosity reduction over Example 1 (no additive) with different amount of hydrophilic bentonite nanoclay as calculated as well.

TABLE 3
Viscosity at testing time of 25 min.

| Additive | Viscosity at | Viscosity |
|---|---|---|
| Concentration | 25 min (cP at | Reduction |
| (pptg) | 100 s⁻¹) | (%) |
| 0 | 495 | — |
| 1.0 | 435 | 12.1 |
| 2.0 | 339 | 31.5 |
| 5.0 | 338 | 31.7 |
| 10.0 | 326 | 34.1 |

### Example 6

In Example 6, an encapsulated high temperature viscosity breaker, ProCap BR (available from Fritz), was added to test the cleanup of the hybrid high temperature fracturing fluid. In Example 6, 4 pptg ProCap BR (24 mg per 50 mL of the fluid) were added to the fluid formulation of Example 2, which includes 1 pptg of the nanoclay. The pH of the mixed fluid was 5.45. Viscosity of the resulting crosslinked fracturing fluid at shear rate of 100 s⁻¹ was measured at 300° F.

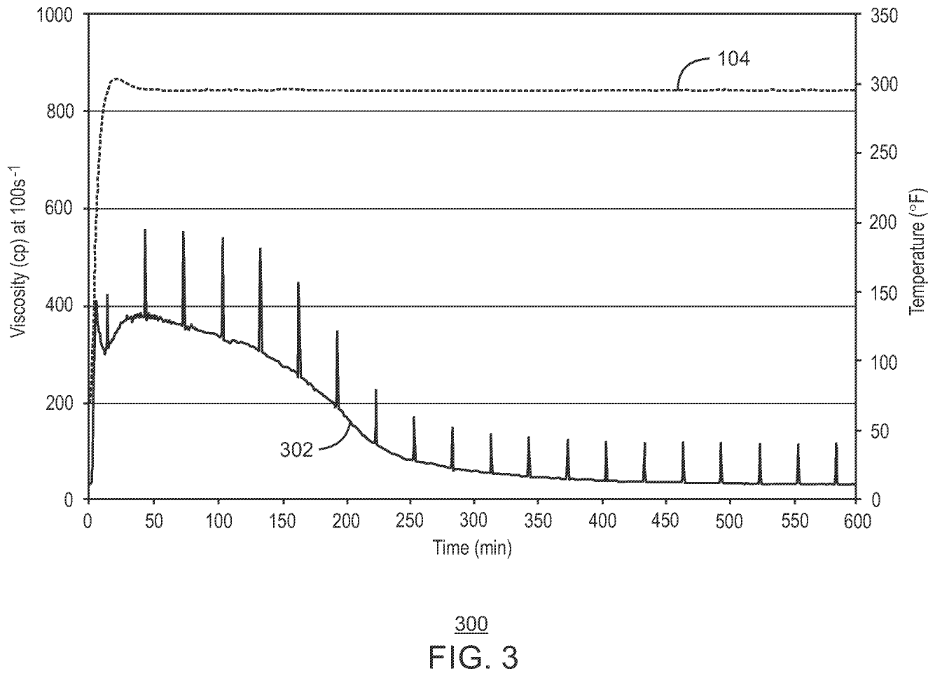

FIG. 3 is a plot 300 that shows the viscosity 302 of the nanoclay assisted fluid in Example 2 with the addition of a viscosity breaker. Like numbered items are as described with respect to FIG. 1. As described herein, example 2 includes 1.0 pptg hydrophilic bentonite nanoclay. The addition of 4 pptg of encapsulated breaker (ProCap BR) allows the viscosity 302 to maintain above 300 cP for at least 80 min, then drop to about 10 cP after about 360 min.

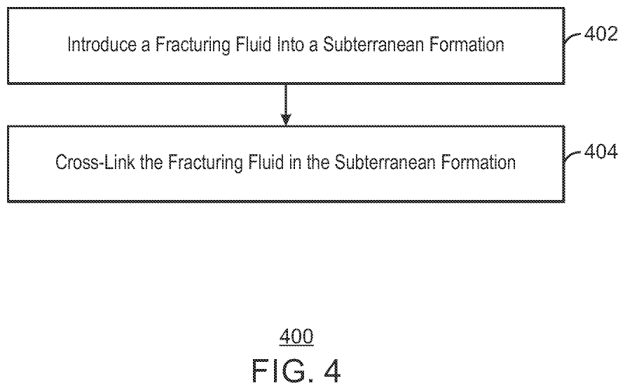

FIG. 4 is a process flow diagram of a method 400 for treating a formation with a fracturing fluid comprising the mixtures described herein. The method begins at block 402, when a fracturing fluid is introduced into a subterranean formation. In some embodiments, the fracturing fluid includes an aqueous copolymer composition comprising a copolymer, the copolymer comprising 2-acrylamido-2-methylpropane-sulfonic acid monomer units, acrylamide monomer units, and acrylic acid monomer units, or a salt thereof. In some embodiments, the fracturing fluid includes an aqueous copolymer composition comprising a copolymer, the copolymer comprising acrylamide monomer units, or acrylic acid monomer units, or both, or salts thereof. In some embodiments, the fracturing fluid includes a crosslinker comprising a metal. In some embodiments, the fracturing fluid includes a nanoclay, wherein the fracturing fluid comprises greater than 1 pounds per thousand gallons (pptg) of the nanoclay. At block 404, the fracturing fluid is cross-linked in the subterranean formation to yield a cross-linked fracturing fluid.

### Definitions

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

In the methods of manufacturing described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

As used herein, the term “polymer” refers to a molecule having at least one repeating unit and can include copolymers.

The term “copolymer” as used herein refers to a polymer that includes at least two different repeating units. A copolymer can include any suitable number of repeating units.

As used herein, the term “fracturing fluid” refers to fluids or slurries used downhole during hydraulic fracturing operations.

As used herein, the term “fluid” refers to gases, liquids, gels, slurries with a high solids content, and critical and supercritical materials.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, water control, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

An embodiment described herein provides a fracturing fluid. The fracturing fluid includes a mixture of an aqueous copolymer composition including a copolymer, the copolymer including acrylamide monomer units, or acrylic acid monomer units, or both, or salts thereof. The mixture also includes a crosslinker including a metal and a friction reducing additive, wherein the friction reducing additive comprises a nanoclay.

In an aspect, the copolymer includes 2-acrylamido-2-methylpropanesulfonic acid monomer units. In an aspect, the fracturing fluid includes 1 to 20 pounds of the nanoclay per thousand gallons of the fracturing fluid. In an aspect, the fracturing fluid includes about 2 pounds of the nanoclay per thousand gallons of the fracturing fluid. In an aspect, the nanoclay includes a phyllosilicate structure with a thickness of about 1 nanometer (nm).

In an aspect, a weight ratio of the metal to the copolymer is in a range of 0.01 to 0.8. In an aspect, a weight ratio of the metal to the copolymer is in a range of 0.2 to 0.6. In an aspect, the copolymer includes 1 mol % to 25 mol % of the 2-acrylamido-2-methylpropanesulfonic acid monomer units. In an aspect, the copolymer includes about 15 mol % of the 2-acrylamido-2-methylpropanesulfonic acid monomer units.

In an aspect, the fracturing fluid includes at least one of a gel stabilizer, a clay stabilizer, a viscosity breaker, a proppant, and a pH adjusting agent. In an aspect, the fracturing fluid includes the pH adjusting agent, wherein a pH of the fracturing fluid is in a range of 3 to 6.5. In an aspect, the fracturing fluid includes between 50 mg/L and 50,000 mg/L of total dissolved solids.

In an aspect, a concentration of the metal in the fracturing fluid is in a range of 0.001 wt % to 0.24 wt %. In an aspect, the fracturing fluid includes 20 to 50 pounds of the copolymer per thousand gallons of the fracturing fluid. In an aspect, after crosslinking, the fracturing fluid has a viscosity of at least 300 cP for at least 80 minutes when subjected to a shear rate of 100 s−1 at a temperature in a range of 300° F. to 400° F. In an aspect, a viscosity of the fracturing fluid measured at 100 s⁻¹ is reduced by greater than 30% by the addition of 2 pounds per thousand gallons of the nanoclay.

Another embodiment described herein provides a method of treating a subterranean formation. The method includes introducing a fracturing fluid into the subterranean formation, wherein the fracturing fluid includes an aqueous copolymer composition including a copolymer, the copolymer including acrylamide monomer units, or acrylic acid monomer units, or both, or salts thereof. The fracturing fluid includes a crosslinker including a metal and a friction reducing additive, wherein the friction reducing additive comprises a nanoclay, wherein the fracturing fluid includes greater than 1 pounds per thousand gallons (pptg) of the nanoclay. The method includes crosslinking the fracturing fluid in the subterranean formation to yield a crosslinked fracturing fluid.

In an aspect, the copolymer includes 2-acrylamido-2-methylpropanesulfonic acid monomer units. In an aspect, a weight ratio of the metal to the copolymer is in a range of 0.01 to 0.8. In an aspect, the method includes adding the nanoclay as a dry powder after hydrating the copolymer. In an aspect, a concentration of the metal in the fracturing fluid is in a range of 0.001 wt % to 0.24 wt %. In an aspect, the fracturing fluid includes 20 to 50 pounds of the crosslinker to of the copolymer.

In an aspect, the crosslinker includes zirconium, the fracturing fluid includes 25 pounds of the copolymer per thousand gallons of the fracturing fluid, a weight ratio of the zirconium to the copolymer is in a range of about 0.2 to about 0.4, the copolymer includes 15 mol % of the 2-acrylamido-2-methylpropane-sulfonic acid monomer units, and the crosslinked fracturing fluid maintains a viscosity of at least 300 cP for up to 150 minutes when the crosslinked fracturing fluid is subjected to a shear rate of 100 s−1 at a temperature of 300° F.

In an aspect, the crosslinked fracturing fluid includes a viscosity breaker, and the crosslinked fracturing fluid maintains a viscosity of at least 300 cP for up to 100 minutes and has a viscosity of less than 10 cP after 360 minutes when the crosslinked fracturing fluid is subjected to a shear rate of 100 s−1 at a temperature of 300° F.

Another embodiment described herein includes a fracturing fluid. The fracturing fluid includes a mixture of an aqueous copolymer composition including a copolymer, the copolymer including 2-acrylamido-2-methylpropanesulfonic acid, acrylamide, and acrylic acid monomer units, or a salt thereof, and wherein the copolymer includes 1 mol % to 55 mol % of the 2-acrylamido-2-methylpropanesulfonic acid monomer units. The mixture includes a crosslinker including a metal and a friction reducing additive, wherein the friction reducing additive comprises a nanoclay, wherein the nanoclay includes particles less than about 25 micrometers in size.

In an aspect, the nanoclay includes a hydrophilic bentonite. In an aspect, the nanoclay includes a sheet structure having a thickness of about 1 nanometer (nm) and a width between about 50-150 nm in one dimension.

### OTHER EMBODIMENTS

It is to be understood that while embodiments have been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A fracturing fluid comprising a mixture of:
an aqueous copolymer composition comprising a copolymer, the copolymer comprising acrylamide monomer units, or acrylic acid monomer units, or both, or salts thereof;
a crosslinker comprising a metal; and
a friction reducing additive, wherein the friction reducing additive comprises a nanoclay.

2. The fracturing fluid of claim 1, wherein the copolymer comprises 2-acrylamido-2-methylpropane-sulfonic acid monomer units or salts thereof.

3. The fracturing fluid of claim 1, wherein the fracturing fluid comprises 1 to 20 pounds of the nanoclay per thousand gallons of the fracturing fluid (0.12 kg/kL to 2.4 kg/kL).

4. The fracturing fluid of claim 1, wherein the fracturing fluid comprises about 2 pounds of the nanoclay per thousand gallons of the fracturing fluid.

5. The fracturing fluid of claim 1, wherein the nanoclay comprises a phyllosilicate structure with a thickness of about 1 nanometer (nm).

6. The fracturing fluid of claim 1, wherein a weight ratio of the metal to the copolymer is in a range of 0.01 to 0.8.

7. The fracturing fluid of claim 1, wherein a weight ratio of the metal to the copolymer is in a range of 0.2 to 0.6.

8. The fracturing fluid of claim 2, wherein the copolymer comprises 1 mol % to 25 mol % of the 2-acrylamido-2-methylpropanesulfonic acid monomer units.

9. The fracturing fluid of claim 8, wherein the copolymer comprises about 15 mol % of the 2-acrylamido-2-methylpropanesulfonic acid monomer units.

10. The fracturing fluid of claim 1, comprising at least one of a gel stabilizer, a clay stabilizer, a viscosity breaker, a proppant, and a pH adjusting agent.

11. The fracturing fluid of claim 10, comprising the pH adjusting agent, wherein a pH of the fracturing fluid is in a range of 3 to 6.5.

12. The fracturing fluid of claim 1, comprising between 50 mg/L and 50,000 mg/L of total dissolved solids.

13. The fracturing fluid of claim 1, wherein a concentration of the metal in the fracturing fluid is in a range of 0.001 wt % to 0.24 wt %.

14. The fracturing fluid of claim 1, wherein the fracturing fluid comprises 20 to 50 pounds of the copolymer per thousand gallons (2.4 kilogram/kiloliter, kg/kL to 6.0 kg/kL) of the fracturing fluid.

15. The fracturing fluid of claim 1, wherein, after crosslinking, the fracturing fluid has a viscosity of at least 300 cP for at least 80 minutes when subjected to a shear rate of 100 s⁻¹ at a temperature in a range of 300° F. to 400° F.

16. The fracturing fluid of claim 1, wherein a viscosity of the fracturing fluid measured at 100 s⁻¹ is reduced by greater than 30% by adding 2 pounds per thousand gallons of the nanoclay to the fracturing fluid (0.24 kg/kL).

17. A method of treating a subterranean formation, the method comprising:
introducing a fracturing fluid into the subterranean formation, the fracturing fluid comprising:
an aqueous copolymer composition comprising a copolymer, the copolymer comprising acrylamide monomer units, or acrylic acid monomer units, or both, or salts thereof;
a crosslinker comprising a metal; and
a friction reducing additive, wherein the friction reducing additive comprises a nanoclay, wherein the fracturing fluid comprises greater than 1 pounds per thousand gallons (pptg) (0.12 kg/kL) of the nanoclay; and
crosslinking the fracturing fluid in the subterranean formation to yield a crosslinked fracturing fluid.

18. The method of claim 17, wherein the copolymer comprises 2-acrylamido-2-methylpropane-sulfonic acid monomer units.

19. The method of claim 17, wherein a weight ratio of the metal to the copolymer is in a range of 0.01 to 0.8.

20. The method of claim 17, comprising adding the nanoclay as a dry powder after hydrating the copolymer.

21. The method of claim 17, wherein a concentration of the metal in the fracturing fluid is in a range of 0.001 wt % to 0.24 wt %.

22. The method of claim 17, wherein the fracturing fluid comprises 20 to 50 pounds of the crosslinker to of the copolymer.

23. The method of claim 22, wherein the crosslinker comprises zirconium, the fracturing fluid comprises 25 pounds of the copolymer per thousand gallons of the fracturing fluid (3.0 kg/kL), a weight ratio of the zirconium to the copolymer is in a range of about 0.2 to about 0.4, the copolymer comprises 15 mol % of the 2-acrylamido-2-methylpropane-sulfonic acid monomer units, and the crosslinked fracturing fluid maintains a viscosity of at least 300 cP for up to 150 minutes when the crosslinked fracturing fluid is subjected to a shear rate of 100 s⁻¹ at a temperature of 300° F. (149° C.).

24. The method of claim 23, wherein the crosslinked fracturing fluid comprises a viscosity breaker, and the crosslinked fracturing fluid maintains a viscosity of at least 300 cP for up to 100 minutes and has a viscosity of less than 10 cP after 360 minutes when the crosslinked fracturing fluid is subjected to a shear rate of 100 s⁻¹ at a temperature of 300° F. (149° C.).

25. A fracturing fluid comprising a mixture of:
an aqueous copolymer composition comprising a copolymer, the copolymer comprising 2-acrylamido-2-methylpropanesulfonic acid, acrylamide, and acrylic acid monomer units, or a salt thereof, and wherein the copolymer comprises 1 mol % to 55 mol % of the 2-acrylamido-2-methylpropanesulfonic acid monomer units;
a crosslinker comprising a metal; and
a friction reducing additive, wherein the friction reducing additive comprises a nanoclay, wherein the nanoclay comprises particles less than about 25 micrometers in size.

26. The fracturing fluid of claim 25, wherein the nanoclay comprises a hydrophilic bentonite.

27. The fracturing fluid of claim 25, wherein the nanoclay comprises a sheet structure sheet structure having a thickness of about 1 nanometer (nm) and a width between about 50-150 nm in one dimension.
